(19) United States
(12) Patent Application Publication
(10) Pub. No.: US 2017/0116421 A1
(43) Pub. Date: Apr. 27, 2017

(54) SECURITY VULNERABILITIES

(71) Applicant: Hewlett Packard Enterprise Development LP, Houston, TX (US)

(72) Inventors: Chandan M C, Bangalore (IN); Rajashekar Dasari, Bangalore (IN)

(21) Appl. No.: 15/141,882

(22) Filed: Apr. 29, 2016

(30) Foreign Application Priority Data
Oct. 23, 2015 (IN) 5707/CHE/2015

(51) Int. Cl. G06F 21/57; G06F 17/30; H04L 29/06

(52) U.S. Cl. CPC G06F 21/577; H04L 63/1433; G06F 17/30424; G06F 17/30345

(57) ABSTRACT

Examples of techniques for handling security vulnerabilities are described herein. According to an example, on finding a publication of a security vulnerability alert, alert data corresponding to the security vulnerability alert is extracted. Thereafter, the alert data is parsed into a structured format. Further, an input data file is generated based on the parsed alert data. Based on the input data file, it is determined whether an Information Technology (IT) resource, implemented in a cloud environment, is in a vulnerable state.

### BACKGROUND

Information Technology (IT) resources, such as servers, network devices, applications, operating systems, and the like, that are deployed by an organization may suffer from security vulnerabilities. Security vulnerability may be understood as a flaw in an IT resource that could be exploited to compromise the security of the IT resource. The security vulnerabilities may result from technology constraints, configuration errors, or security policy weaknesses. In an example, security vulnerability in an IT resource may result from complexities, bugs, or design flaws in the IT resource.

### BRIEF DESCRIPTION OF THE DRAWINGS

The following detailed description references the drawings, wherein:

FIG. 1 illustrates an example system for handling security vulnerabilities, according to an example of the present subject matter;

FIG. 2 illustrates an example network environment implementing a system for handling security vulnerabilities, according to an example of the present subject matter;

FIG. 3 illustrates an example method of handling security vulnerabilities, according to an example of the present subject matter;

FIG. 4 illustrates another example method of handling security vulnerabilities, according to an example of the present subject matter; and

FIG. 5 illustrates an example network environment for handling security vulnerabilities, according to an example of the present subject matter.

### DETAILED DESCRIPTION

Cloud computing is a distributed computing paradigm that provides Information Technology (IT) services to organizations over the Internet. The organizations may use IT resources from multiple IT vendors to procure these IT services. However, the IT resources may suffer from security vulnerabilities. Security vulnerability is a flaw in an IT resource that could allow an attacker to compromise integrity, availability, or confidentiality of the IT resource. To protect the IT resources, security vulnerabilities have to be identified so that they can be remediated.

Generally, organizations deploy a team of security professionals to regularly monitor multiple data sources for latest security vulnerability alerts published by various IT vendors. In an example, an IT vendor may publish a security vulnerability alert on its website if it is found that any of its IT resources is vulnerable to an exploit. The security vulnerability alert may indicate, along with other information, severity of the vulnerability and a security patch to fix the vulnerability. On finding the publication of a new security vulnerability alert, the security professionals may assess the security vulnerability alert. For example, the security professionals may assess potential damage that the vulnerability can cause to the IT resources, instructions for applying the security patch, and the like.

Thereafter, the security professionals may run a scan on the IT resources to determine whether any of the IT resources is vulnerable. If an IT resource is found to be vulnerable, the security professionals may download and install the security patch specified with the security vulnerability alert to fix the vulnerability. However, manually monitoring multiple data sources for security vulnerability alerts and assessing the security vulnerability alerts is not just labor intensive but also error prone, time consuming, and inefficient. Further, there may be a case where two or more security professionals may individually assess the same security vulnerability alert. This may lead to duplication of efforts and increase in operational costs.

Approaches for handling security vulnerabilities are described. In an example, the handling of the security vulnerabilities may be understood as including one or more of detection, transformation, and assessment of the security vulnerabilities. In accordance with an example implementation, a plurality of data sources may be monitored by a system for identifying newly published security vulnerability alerts pertaining to IT resources. In an example, the IT resources may comprise network devices, applications, servers, Operating System (OS) platforms, and the like. The various data sources may be managed by different IT vendors of the IT resources. The published security vulnerability alerts may provide information about current security issues, vulnerabilities, and exploits. In an example, a vendor may publish a security vulnerability alert after discovering security vulnerability in an IT resource that is provided by the vendor to its customers. Examples of the data sources include, but are not limited to, websites maintained by IT vendors, Rich Site Summary (RSS) feeds, pages published by IT vendors, and the like.

On finding a publication of a security vulnerability alert, data relating to the security vulnerability alert is extracted by the system. For example, data such as a description of security vulnerability corresponding to the security vulnerability alert, a list of affected IT resources, and a security patch to fix the security vulnerability may be extracted. In an example, the data that is extracted may be in an unstructured or a semi-structured format. Subsequently, the data may be parsed by the system and saved in a structured format in a database.

Thereafter, an input data file is generated by the system based on the parsed data. In an example, the input data file may be a JavaScript Object Notation (JSON) file, an Extensible Markup Language (XML) file, or a script file. The input data file may then be utilized to scan the IT resources to determine whether IT resources are in a vulnerable state with reference to the security vulnerability alert.

With the approaches described herein, operational cost, time, and errors associated with handling of the security vulnerability alerts are substantially reduced. Further, efficiency in handling the security vulnerabilities is increased. The various approaches are further described in conjunction with the following figures. It should be noted that the description and figures merely illustrate the principles of the present subject matter. Further, various arrangements may be devised that, although not explicitly described or shown herein, embody the principles of the present subject matter and are included within its scope.

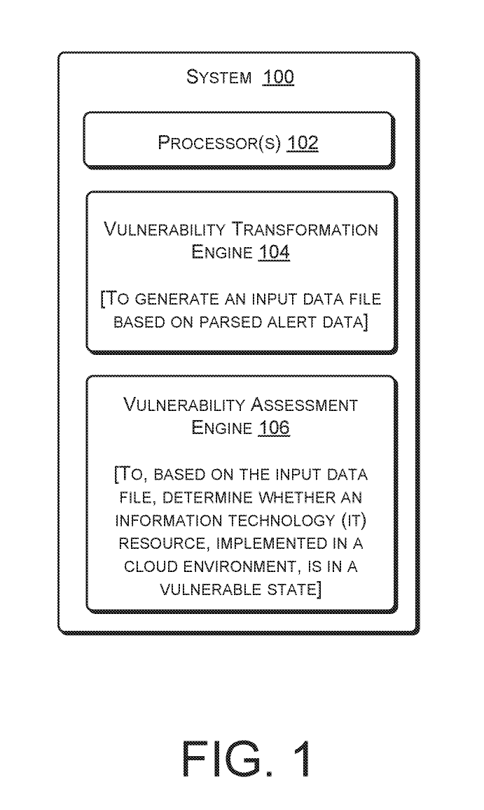

The above approaches are further described with reference to FIGS. 1 to 5. It should be noted that the description and figures merely illustrate the principles of the present subject matter. It may be understood that various arrangements may be devised that, although not explicitly described or shown herein, embody the principles of the present subject matter. Further, while aspects of described system and method for handling the security vulnerabilities may be implemented in any number of different computing systems, environments, and/or implementations, the examples and implementations are described in the context of the following system(s).

FIG. 1 illustrates an example system 100 for handling security vulnerabilities, according to an example of the present subject matter. The system 100 may be implemented in various ways. For example, the system 100 may be a special purpose computer, a server, a mobile computing device, and/or any other type of computing device.

The system 100 includes processor(s) 102. The processor(s) 102 may be implemented as microprocessors, microcomputers, microcontrollers, digital signal processors, central processing units, state machines, logic circuitries, and/or any devices that manipulate signals based on operational instructions. Among other capabilities, the processor(s) 102 may fetch and execute computer-readable instructions stored in a memory coupled to the processor(s) 102 of the system 100. The memory may include any non-transitory computer-readable storage medium including, for example, volatile memory (e.g., RAM), and/or non-volatile memory (e.g., EPROM, flash memory, NVRAM, memristor, etc.). The functions of the various elements shown in FIG. 1, including any functional blocks labeled as “processor(s)”, may be provided through the use of dedicated hardware as well as hardware capable of executing computer-readable instructions.

As shown in FIG. 1, the system 100 includes a vulnerability transformation engine 104 and a vulnerability assessment engine 106. The vulnerability transformation engine 104 and the vulnerability assessment engine 106, amongst other things, include routines, programs, objects, components, data structures, and the like, which perform particular tasks or implement particular abstract data types. The vulnerability transformation engine 104 and the vulnerability assessment engine 106 may be coupled to, and executed by, the processor(s) 102 to perform various functions for handling security vulnerabilities.

In operation, the vulnerability transformation engine 104 may monitor a plurality of data sources (not shown in FIG. 1) for published security vulnerability alerts pertaining to Information Technology (IT) resources. The published security vulnerability alerts may provide information about current security issues, vulnerabilities, and exploits. Further, the data sources may include websites of IT vendors, Rich Site Summary (RSS) feeds, pages published by IT vendors, and the like. The address or location of the data sources to be monitored may be provided as an input, for example, by a system security manager.

In an example, the vulnerability transformation engine 104 may periodically search the data sources for published security vulnerability alerts. In another example, the vulnerability transformation engine 104 may search one or more of the data sources for the published security vulnerability alerts on receiving a user input. In an example, the vulnerability transformation engine 104 may identify a security vulnerability alert published in a predefined time period as a new or latest security vulnerability alert. The predefined time period may be, for example, the time period between a previous search and a current search.

On finding the publication of a security vulnerability alert, the vulnerability transformation engine 104 may extract alert data corresponding to the published security vulnerability alert. In an example, the alert data corresponding to the published security vulnerability alert may comprise at least one of a unique identifier associated with the security vulnerability alert, a name of a security vulnerability associated with the security vulnerability alert, a description of the security vulnerability, a security patch for fixing the security vulnerability, and an assigned priority level for the security vulnerability.

Subsequently, the vulnerability transformation engine 104 may parse the alert data corresponding to the security vulnerability alert for saving in a structured format. In an example, the alert data that is extracted may be in an unstructured or a semi-structured format. According to an example, the alert data extracted from the data sources may be in a HyperText Markup Language (HTML) format. The vulnerability transformation engine 104 may parse the alert data for storing in a database in a structured format in various data fields.

Thereafter, the vulnerability transformation engine 104 may generate an input data file based on the parsed alert data. The input data file may be utilized to assess IT resources for security vulnerabilities. In an example, the input data file may be a JavaScript Object Notation (JSON) file, an Extensible Markup Language (XML) file, or a script file. The input data file may be created based on pre-stored input data file templates. Likewise, an input data file may be generated for each security vulnerability alert that is published by an IT vendor.

In an example implementation, the vulnerability transformation engine 104 may store the input data files in a database for future reference. In an example, when the system 100 receives a request from a user to determine whether an IT resource is in a vulnerable state, the vulnerability assessment engine 106 may retrieve the input data files. An IT resource is said to be in a vulnerable state if it is found to be exploitable due to security vulnerability. Based on the input data files, the vulnerability assessment engine 106 may determine whether the IT resource is in the vulnerable state. Aspects of handling the security vulnerability alerts are further described below.

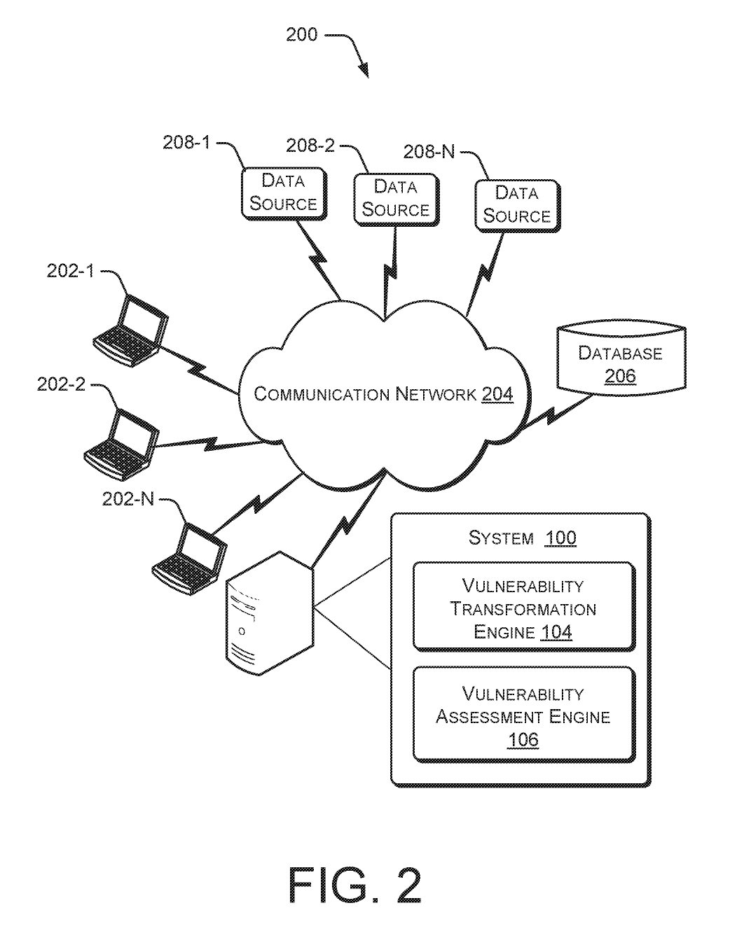

FIG. 2 illustrates an example network environment 200 implementing the system 100 for handling security vulnerabilities, according to an example of the present subject matter. The network environment 200 may be a public network environment or a private network environment or a combination of the two. The system 100 may be a computing device, for example, a server, as shown in FIG. 2. In an example, the system 100 may include the vulnerability transformation engine 104 and the vulnerability assessment engine 106.

Further, the network environment 200 includes user devices 202-1, 202-2, . . . , 202-N, through which a plurality of users can access the system 100 for determining whether IT resources are vulnerable to IT attacks. The IT resources may include servers, network devices, applications, operating systems, and the like. In an example, the system 100, the user devices 202, and the IT resources may be deployed in a cloud environment. Cloud environment is a distributed computing paradigm that provides IT services, such as software services, platform services, and infrastructure services to organizations over the Internet. The IT resources may be deployed by the organizations and may be provided to them by multiple IT vendors. The organizations may procure the IT services using these IT resources. According to an example, the system 100 may be deployed by an organization comprising a plurality of IT resources. The system 100 may be utilized to handle security vulnerabilities in the IT resources deployed by the organization.

Further, the user devices 202 may include, but are not limited to, laptops, desktop computers, tablets, and the like. Further, the user devices 202 and the system 100 may be communicatively coupled to each other through a communication network 204. The communication network 204 may be a wireless network, a wired network, or a combination thereof. The communication network 204 can also be an individual network or a collection of many such individual networks, interconnected with each other and functioning as a single large network, e.g., the Internet or an intranet. The communication network 204 can be implemented as one of the different types of networks, such as intranet, local area network (LAN), wide area network (WAN), and the internet. The communication network 204 may either be a dedicated network or a shared network, which represents an association of the different types of networks that use a variety of protocols, for example, Hypertext Transfer Protocol (HTTP) and Transmission Control Protocol/Internet Protocol (TCP/IP), to communicate with each other.

In an example implementation, the user devices 202 and the system 100 may be communicatively coupled over the communication network 204 through one or more communication links. The communication links are enabled through a desired form of communication, for example, via dial-up modem connections, cable links, and digital subscriber lines (DSL), wireless or satellite links, or any other suitable form of communication. While FIG. 2 shows the user devices 202 and the system 100 communicatively coupled through the communication network 204, the user devices 202 may be directly coupled to the system 100.

Further, as shown in FIG. 2, the system 100 may be communicatively coupled to a database 206 through the communication network 204. The database 206 may serve as a repository for storing data that may be fetched, processed, received, or generated by the system 100. In an example, the data generated by the system 100 may be transmitted to the database 206, and the data stored in the database 206 may be fetched by the system 100, over the communication network 204. Although, the database 206 is shown external to the system 100, it may be understood that the database 206 can reside inside the system 100. Further, while FIG. 2 shows the database 206 and the system 100 communicatively coupled through the communication network 204, the database 206 may be directly coupled to the system 100.

Further, the system 100 may be communicatively coupled to a plurality of data sources 208-1, 208-2, . . . , 208-N, through the communication network 204. In an example, the data sources 208 may be customer-accessible data sources that may be managed by different IT vendors of IT resources. A customer may be an end user, such as an organization who uses IT resources of an IT vendor. In an example, on discovering security vulnerability in an IT resource provided by an IT vendor to its customers, the IT vendor may publish a security vulnerability alert in a customer-accessible data source. According to an example, the data sources 208 may include websites of IT vendors, Rich Site Summary (RSS) feeds, pages published by IT vendors, and the like. The description hereinafter describes, in detail, the procedure of handling of security vulnerabilities.

In operation, the vulnerability transformation engine 104 may monitor the data sources 208 for published security vulnerability alerts pertaining to IT resources. The security vulnerability alerts may provide information about security vulnerabilities associated with the IT resources. In an example, security vulnerability in an IT resource may be understood as a flaw in the IT resource that could allow an attacker to compromise integrity, availability, or confidentiality of the IT resource. In an example, security vulnerabilities may result from technology constraints, configuration errors, or security policy weaknesses. For example, network devices, such as routers, firewalls, and switches, may have security weaknesses relating to password protection, lack of authentication, routing protocols, and firewall holes. The security vulnerabilities have to be addressed to mitigate any threat that could take advantage of the vulnerabilities.

According to an example, an application developed by an IT vendor may comprise an unintended defect. Once an attacker has found the defect, and determined how to access it, the attacker has the potential to exploit the defect to facilitate a cyber crime. The cyber crime may target confidentiality, integrity, or availability of the application. When the IT vendor finds the defect in the application, the IT vendor may develop a security patch to fix the defect. Further, the IT vendor may also publish a security vulnerability alert for users of the application to inform the users about the security vulnerability. According to the example, the IT vendor may publish the security vulnerability alert on its website.

Returning to the operation of the vulnerability transformation engine 104, in an example, the vulnerability transformation engine 104 may regularly monitor the data sources 208 for published security vulnerability alerts. In another example, the vulnerability transformation engine 104 may monitor the data sources 208 on receiving a user input. In said example, the user may be a system security manager of an organization in which the system 100 is deployed. The system security manager may be responsible for handling security of IT resources deployed by the organization.

In an example, the vulnerability transformation engine 104 may receive an input from a user to determine whether a new security vulnerability alert is published by IT vendor. On receiving the input, the vulnerability transformation engine 104 may assess a data source managed by the IT vendor to determine whether any new security vulnerability alert is published. In an example, the vulnerability transformation engine 104 may identify a security vulnerability alert published in a predefined time period as a new or latest security vulnerability alert. The predefined time period may be, for example, the time period between a previous search and a current search. According to an example, the vulnerability transformation engine 104 may receive the user input when the user clicks on a mouse or types on a keyboard.

As mentioned above, the data sources 208 may be the websites of the IT vendors, RSS feeds, pages published by the IT vendors, and the like. Accordingly, in an example, the vulnerability transformation engine 104 may use a Uniform Resource Locator (URL) to access IT vendor published pages or RSS feeds to monitor for the security vulnerability alerts. On detecting a newly published security vulnerability alert, in an example, the vulnerability transformation engine 104 may extract alert data corresponding to the security vulnerability alert. In another example, the vulnerability transformation engine 104 may download a source page or a document that includes the security vulnerability alert to extract the alert data.

The alert data corresponding to the security vulnerability alert may comprise at least one of a unique identifier associated with the security vulnerability alert, a name of a security vulnerability associated with the security vulnerability alert, a date of publication of the security vulnerability, a description of the security vulnerability, a security patch for fixing the security vulnerability, and an assigned priority level for the security vulnerability. Further, the description of the security vulnerability may indicate a list of affected IT resources, versions of the affected IT resources, technical details of the published security vulnerability, current exploitation status of the published security vulnerability, and consequences of the exploitation.

According to an example implementation, the vulnerability transformation engine 104 may extract alert data corresponding to each published security vulnerability alert. The alert data that is extracted from the data sources 208 may be in an unstructured or semi-structured format. For instance, the extracted alert data may be in a HyperText Markup Language (HTML) format or in a text document. Since, there is no dependency on security professionals for monitoring of the data sources 208 for newly published security vulnerability alerts and extraction of data corresponding to the security vulnerability alerts, time, errors, and operational costs associated with detection of the security vulnerability alerts and extraction of alert data are substantially reduced. Further, as described above, the vulnerability transformation engine 104 may regularly monitor the data sources 208 for newly published security vulnerability alerts, therefore the system 100 is updated with the newly published security vulnerability alerts.

An example of extracted alert data corresponding to the published security vulnerability alerts is depicted in Table 1 (provided below).

TABLE 1

| DATE | | | |
|---|---|---|---|
| OF | IDENTIFICATION | | |
| PUBLICATION | NUMBER | TITLE | STATUS |
| Jul. 20, 2015 | 3079904 | Vulnerability in | Critical |
| | | ‘X’ font driver | |
| | | could allow | |
| | | remote code | |
| | | execution | |
| Jul. 14, 2015 | 3079876 | Vulnerability in | Important |
| | | ‘Y’ font driver | |
| | | could allow | |
| | | elevation of | |
| | | privilege | |
| Jul. 14, 2015 | 3076785 | Vulnerability in | Important |
| | | ‘Z’ font driver | |
| | | could allow | |
| | | remote code | |
| | | execution | |
| Jul. 12, 2015 | 3075604 | Vulnerability in | Important |
| | | ‘A’ installer | |
| | | service could | |
| | | allow elevation | |
| | | of privilege | |

On extracting the alert data, the vulnerability transformation engine 104 parses the extracted data into a structured format. For instance, the alert data may be parsed into data fields and corresponding values. According to an example, a data field may be a name of an IT resource that is affected by security vulnerability and values may correspond to versions of the affected IT resource. In an example, the alert data may be parsed and saved in an Extensible Markup Language (XML) format in a database (not shown in FIG. 2).

In an example, the extracted alert data may be parsed in the structured format to identify logical relationship between the data fields and their corresponding values. For instance, the vulnerability transformation engine 104 may identify logical relationships between different values of the same data field or between corresponding values of different data fields. According to an example, the logical relationships may include Boolean relationships. Further, the logical relationships may be utilized while assessing IT resources for security vulnerabilities.

On parsing the alert data, the vulnerability transformation engine 104 may use the parsed data to generate an input data file for each security vulnerability alert. In an example, the input data file may be a JavaScript Object Notation (JSON) file, an XML file, or a script file. The input data file may be generated based on a template file that includes various fields to be populated based on the parsed data for generation of the input data file. The input data files may be used for scanning IT resources to determine whether the IT resources are in a vulnerable state. In an example, the vulnerability transformation engine 104 may store the input data files in the database 206. Accordingly, the database 206 may comprise an input data file corresponding to each security vulnerability alert.

An example of a sample input data file is provided in Table 2 below.

TABLE 2

```
{
  “ACTION”:” SCAN AND REMEDIATION”,
  “MS15-078”: {
    “KB3079904”: {
          “Binary”: “Windows6.0-KB3079904-x86.msu”,
          “canReboot”: “YES/NO”,
          “OS”: “Windows Server 2008”,
          “ARCH”: “X86”,
  “FileInfo”: “[‘Atmfd.dll’:’5.1.2.243’,’Atmlib.dll’:’5.1.2.243’,
  ’Dciman32.dll’:1.2.3.4]
```

As can be seen in the above table, the action specified is scan and remediation. Accordingly, this input data file may be used for scanning an IT resource for security vulnerability, and on determination of the security vulnerability, remediating the security vulnerability. Although, it is shown that the action is scan and remediation, in an implementation, the action may be scan without remediation. As shown in the above table, this input data file is for a security vulnerability alert “MS15-078” having knowledge base (KB) number “KB3079904”. Further, the input data file also indicates that version 6.0 of the Windows server 2008 is affected by the security vulnerability alert. The input data file also includes security patch for the security vulnerability alert “MS15-078”. As can be seen, the security patch is included as a file with .msu extension. Furthermore, the input data file also includes dynamic-link library (dll) files. A dll file is an executable file that allows programs to share code and other resources for performing particular tasks.

In an example, the input data files stored in the database 206 may be retrieved when it is to be determined by the system 100 whether an IT resource is vulnerable to security vulnerabilities. The manner in which the system 100 determines whether an IT resource is vulnerable to security vulnerabilities or not is described henceforth.

In an example implementation, the vulnerability assessment engine 106 may initially receive a request from a user of the IT resource to determine whether the IT resource is vulnerable to any of the published security vulnerabilities. The vulnerability assessment engine 106 may receive the request from the user via an interface hosted at the user device 202. In an example, the user may access the system 100 through the user device 202. The user may login to the system 100 through the user device 202. The user may be provided with login credentials in order to allow them to login to the system 100. Thereafter, the vulnerability assessment engine 106 may obtain a resource attribute indicative of the IT resource from the user. The resource attribute may be indicative of at least one of a name of the IT resource, an OS running on the IT resource, a manufacturing date of the IT resource, a serial number of the IT resource, and a product number of the IT resource. In an example, the user may provide a URL of a running instance of the IT resource. It should be noted that the examples of the resource attribute are illustrative, and should not be construed as limitations onto the present subject matter.

Subsequently, based on the resource attribute, the vulnerability assessment engine 106 may identify the IT resource to be assessed for the security vulnerabilities from amongst a plurality of IT resources. For example, based on the URL of the running instance of the IT resource, the vulnerability assessment engine 106 may identify the IT resource. Upon identification of the IT resource, the vulnerability assessment engine 106 may scan the IT resource to determine whether the IT resource is in a vulnerable state. The IT resource is said to be in the vulnerable state if it is found to be exploitable due to security vulnerability. In an example, the vulnerability assessment engine 106 may generate an output data file when an IT resource is scanned against a security vulnerability alert. In said example, an output data file is generated corresponding to each security vulnerability alert.

An example of an output data file is provided in Table 3 below.

TABLE 3

```
{
“Status”: “TRUE”,
“MS15-078”: {
    “KB3079904”: {
        “status”: “true”
        “Binary”: “Windows6.0-KB3079904-x86.msu”,
        “OS”: “Windows Server 2008”,
        “ARCH”: “X86”,
            }
      }
}
```

As can be seen in the above table, the status of the scan result is “true”. That means the IT resource is vulnerable to the security vulnerability alert “MS15-078”. In an example, while scanning an IT resource against a security vulnerability alert, the vulnerability assessment engine 106 may use dll files that are included in an input data file corresponding to the security vulnerability alert, for scanning the IT resource.

Based on the scan result, the vulnerability assessment engine 106 may notify the user whether the IT resource is in the vulnerable state. Further, in case the IT resource is in the vulnerable state, then the vulnerability assessment engine 106 may recommend a security patch to the user of the IT resource for remediating the security vulnerability. As described above, alert data corresponding to a security vulnerability alert comprises a description of security vulnerability and a security patch for fixing the security vulnerability. In an example, the user may download the security patch to fix the problems associated with the security vulnerability. According to an example implementation, the vulnerability assessment engine 106 may scan multiple IT resources in a similar manner as described above to determine whether the IT resources are vulnerable or not.

In another example implementation, on publication of an alert, the vulnerability assessment engine 106 may scan all or possibly affected IT resources for security vulnerability. On finding an IT resource to be vulnerable, the vulnerability assessment engine 106 may generate an alert to notify user of the IT resource.

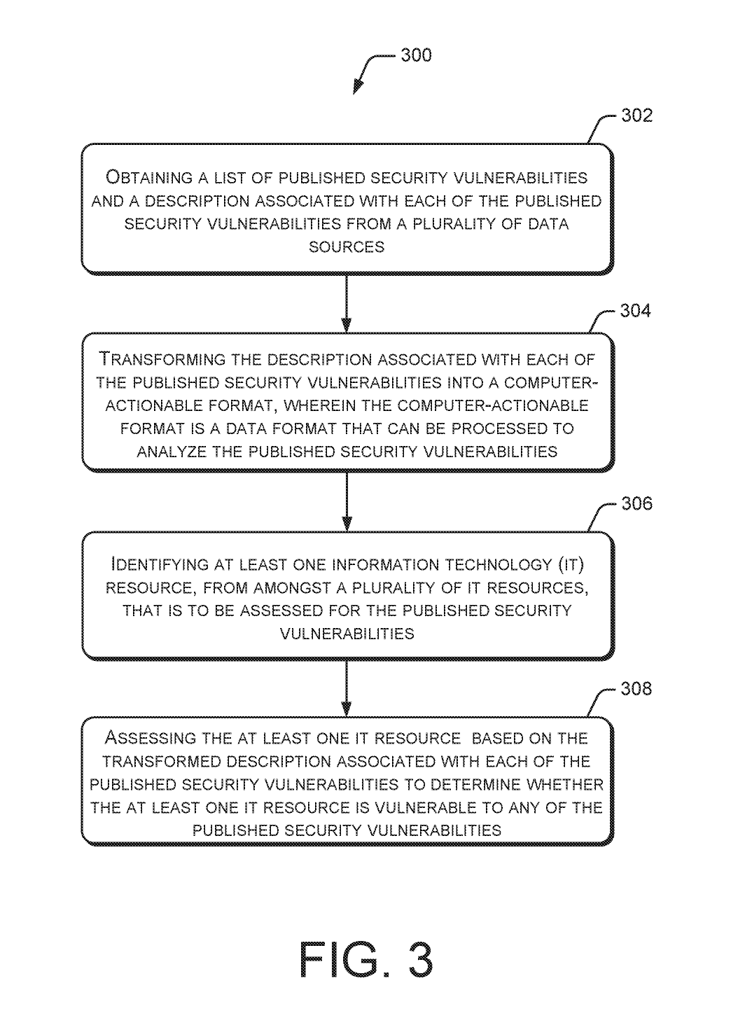

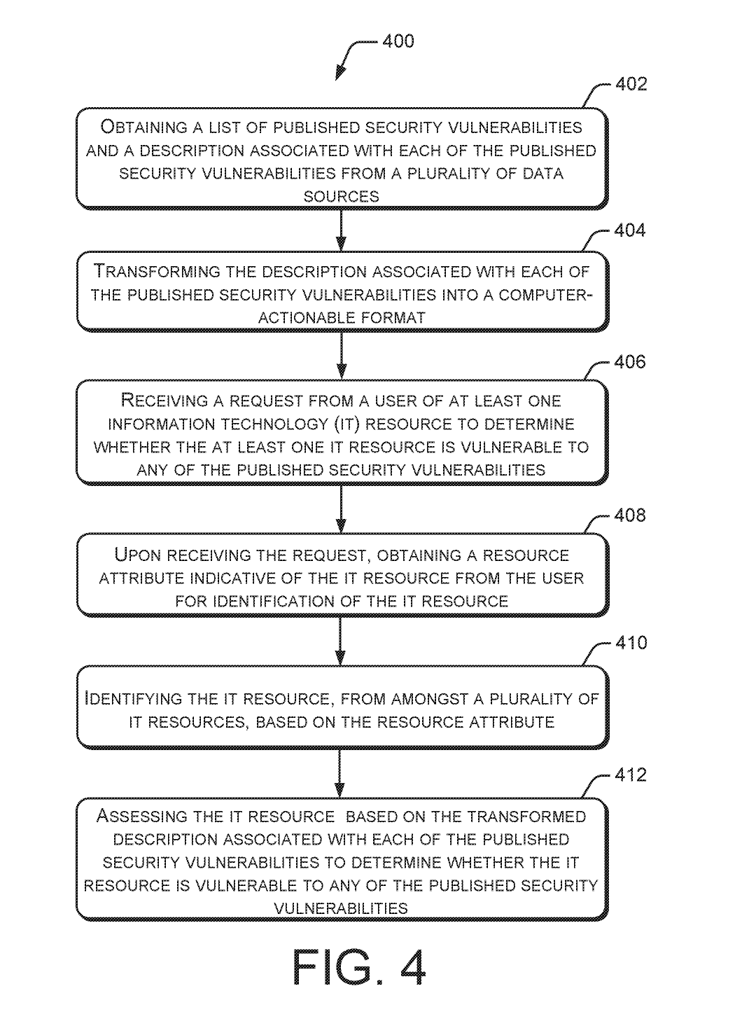

FIGS. 3 and 4 illustrate methods 300 and 400, respectively, for handling security vulnerabilities, according to an example implementation of the present subject matter. The order in which the methods are described is not intended to be construed as a limitation, and any number of the described method blocks may be combined in any order to implement the aforementioned methods, or an alternative method. Furthermore, methods 300 and 400 may be implemented by processing resource or computing device(s) through any suitable hardware, non-transitory machine readable instructions, or combination thereof.

It may also be understood that methods 300 and 400 may be performed by programmed computing devices, such as the system 100 as depicted in FIGS. 1 and 2. Furthermore, the methods 300 and 400 may be executed based on instructions stored in a non-transitory computer readable medium. The non-transitory computer readable medium may include, for example, digital memories, magnetic storage media, such as one or more magnetic disks and magnetic tapes, hard drives, or optically readable digital data storage media. Although, the methods 300 and 400 are described below with reference to the system 100 as described above, other suitable systems for the execution of these methods can also be utilized. Additionally, implementation of these methods is not limited to such examples.

With reference to the method 300 as depicted in FIG. 3, at block 302, the method 300 includes obtaining a list of published security vulnerabilities and a description associated with each of the published security vulnerabilities from a plurality of data sources. In an example, a description associated with published security vulnerability may indicate a list of affected IT resources, versions of the affected IT resources, technical details of the published security vulnerability, current exploitation status of the published security vulnerability, and consequences of the exploitation. Further, the plurality of data sources may include websites of IT vendors, RSS feeds, pages published by IT vendors, and the like. According to an example, the vulnerability transformation engine 104 may obtain the list of published security vulnerabilities and the description associated with each of the published security vulnerabilities from the plurality of data sources 208.

At block 304, the description associated with each of the published security vulnerabilities is transformed into a computer-actionable format. The computer-actionable format is a data format that can be processed to analyze the published security vulnerabilities. The computer-actionable format may be one of a JavaScript Object Notation (JSON) format and an Extensible Markup Language (XML) format. In an example, the description associated with each of the security vulnerabilities may be in a HyperText Markup Language (HTML) format. Accordingly, in an example, the description associated with the security vulnerabilities may be transformed from the HTML format to the JSON format. In an example implementation, the vulnerability transformation engine 104 may transform the description associated with the security vulnerabilities into the computer-actionable format.

At block 306, at least one IT resource, from amongst a plurality of IT resources, that is to be assessed for the published security vulnerabilities is identified. The IT resource may be identified based on its resource attributes. In an example, the resource attributes may be indicative of a name of the IT resource, an OS running on the IT resource, a manufacturing date of the IT resource, a serial number of the IT resource, and a product number of the IT resource. The resource attributes may be obtained from a user of the IT resource. According to an example implementation, the vulnerability assessment engine 106 identifies the at least one IT resource, from amongst the plurality of IT resources, that is to be assessed for the published security vulnerabilities based on its resource attributes.

At block 308, the at least one IT resource is assessed based on the transformed description associated with each of the published security vulnerabilities to determine whether the at least one IT resource is vulnerable to any of the published security vulnerabilities. According to an example, the IT resource may be separately assessed for each of the published security vulnerability. In an example, the vulnerability assessment engine 106 may assess the at least one IT resource based on the transformed description associated with the published security vulnerabilities.

With reference to method 400 as depicted in FIG. 4, at block 402, a list of published security vulnerabilities and a description associated with each of the published security vulnerabilities may be obtained from a plurality of data sources. In an example, a description associated with published security vulnerability may indicate a list of affected Information Technology (IT) resources and their versions, technical details of the security vulnerability, current exploitation status of the security vulnerability, and consequences of the exploitation. The IT resources may include network devices, applications, servers, Operating System (OS) platforms, and the like. Further, the plurality of data sources may include websites of IT vendors, RSS feeds, pages published by IT vendors, and the like.

In an example, an input may be received from a user to determine whether a new security vulnerability is published for an IT vendor. Thereafter, a data source of the IT vendor is accessed to determine whether the new security vulnerability is published. According to an example, the vulnerability transformation engine 104 may obtain the list of published security vulnerabilities and the description associated with each of the published security vulnerabilities from the plurality of data sources 208.

At block 404, the description associated with each of the published security vulnerabilities is transformed into a computer-actionable format. The computer-actionable format is a data format that can be processed to analyze the published security vulnerabilities. In an example, for each of the published security vulnerability alerts, an input data file that is in a computer-actionable format is generated. According to an example, the description associated with the security vulnerabilities may be transformed from the HTML format to the JSON format. In an example implementation, the vulnerability transformation engine 104 may transform the description associated with the security vulnerabilities into the computer-actionable format.

At block 406, a request is received from a user of at least one IT resource to determine whether the IT resource is vulnerable to any of the published security vulnerabilities. The request may be received via an interface hosted at a device of the user. In an example, the vulnerability assessment engine 106 may receive the request from the user of the at least one IT resource to determine whether the IT resource is vulnerable to any of the security vulnerabilities.

At block 408, upon receiving the request, a resource attribute indicative of the IT resource may be obtained from the user for identification of the IT resource. The resource attribute may be indicative of at least one of a name of the IT resource, an OS running on the IT resource, a manufacturing date of the IT resource, a serial number of the IT resource, and a product number of the IT resource. According to an example, the vulnerability assessment engine 106 may receive the resource attribute associated with the IT resource from the user of the IT resource.

At block 410, the IT resource, from amongst a plurality of IT resources, is identified based on the resource attribute. For example, if the user of the IT resource provides a URL of a running instance of the IT resource, then the IT resource may be identified based on the URL of the running instance of the IT resource. In an example, the vulnerability assessment engine 106 may identify the IT resource, from amongst the plurality of IT resources, based on the resource attribute.

At block 412, the IT resource is assessed based on the transformed description associated with each of the published security vulnerabilities to determine whether the IT resource is vulnerable to any of the published security vulnerabilities. Further, on determining the IT resource to be vulnerable to any of the published security vulnerabilities, the user of the IT resource is notified that the IT resource is vulnerable. Further, a remediation action may be recommended to the user of the IT resource for remediating the security vulnerability. The remediation action may be downloading a security patch to fix the security vulnerability. In an example, the vulnerability assessment engine 106 may assess the IT resource based on the resource attribute.

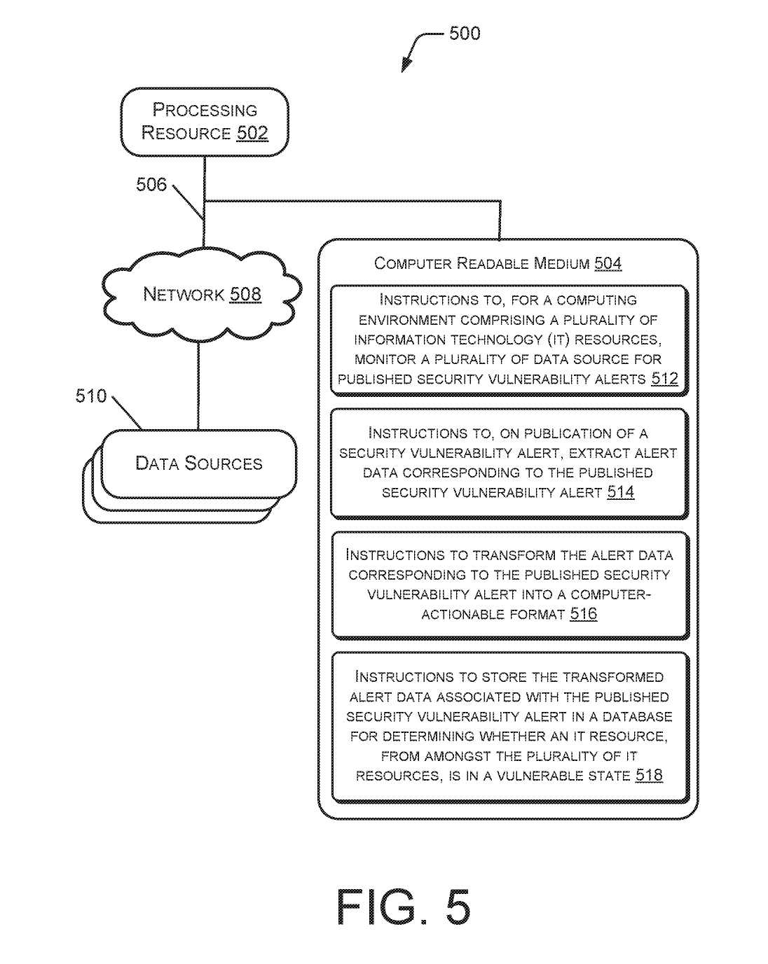

FIG. 5 illustrates an example network environment 500 for handling security vulnerabilities, according to an example of the present subject matter. The network environment 500 may comprise at least a portion of a public networking environment or a private networking environment, or a combination thereof. In an example implementation, the network environment 500 includes a processing resource 502 communicatively coupled to a non-transitory computer readable medium 504, hereinafter referred to as computer readable medium 504, through a communication link 506. In an example, the processing resource 502 can be a computing device, such as a system 100.

The computer readable medium 504 can be, for example, an internal memory device of the computing device or an external memory device. In an example implementation, the communication link 506 may be a direct communication link, such as any memory read/write interface. In another implementation, the communication link 506 may be an indirect communication link, such as a network interface. In such a case, the processing resource 502 can access the computer readable medium 504 through a network 508. The network 508 may be a single network or a combination of multiple networks and may use a variety of different communication protocols.

The processing resource 502 and the computer readable medium 504 may also be coupled to data sources 510 through the communication link 506, and/or to communication devices 512 over the network 508. The coupling with the data sources 510 enables in receiving the requested data in an offline environment, and the coupling with the communication devices 512 enables in receiving the requested data in an online environment.

In an example implementation, the computer readable medium 504 includes a set of computer readable instructions, implementing a vulnerability transformation engine 104 and a vulnerability assessment engine 106. The set of computer readable instructions, referred to as instructions hereinafter, can be accessed by the processing resource 502 through the communication link 506 and subsequently executed to perform acts for transforming and assessing the security vulnerabilities. For discussion purposes, the execution of the instructions by the processing resource 502 has been described with reference to various components introduced earlier with reference to description of FIGS. 1 and 2.

On execution by the processing resource 502, the vulnerability transformation engine 104 for a computing environment comprising a plurality of Information Technology (IT) resources, monitors a plurality of data sources 208 for published security vulnerability alerts. The security vulnerability alerts may provide information about security vulnerabilities associated with the IT resources. Further, the data sources 208 may include websites of IT vendors, Rich Site Summary (RSS) feeds, IT vendor published pages, and the like. In an example, the IT resources may include network devices, applications, servers, and OS platforms. On finding a publication of a security vulnerability alert, the vulnerability transformation module 104 may extract alert data corresponding to the published security vulnerability alert.

In an example, alert data corresponding to a security vulnerability alert may comprise at least one of a unique identifier associated with the security vulnerability alert, a name of a security vulnerability associated with the security vulnerability alert, a description of the security vulnerability, a security patch for fixing the security vulnerability, and an assigned priority level for the security vulnerability. According to said example, the description of the security vulnerability may indicate a list of affected IT resources, versions of the affected IT resources, technical details of the published security vulnerability, current exploitation status of the published security vulnerability, and consequences of exploitation. In an example, the alert data obtained from the data sources 208 may be in a HyperText Markup Language (HTML) format.

Thereafter, the vulnerability transformation engine 104 may parse the alert data corresponding to the published security vulnerability alert into a structured format and store the parsed alert data in a database. The vulnerability transformation engine 104 may transform the alert data corresponding to the security vulnerability alert into a computer-actionable format. The computer-actionable format is a data format that can be processed to analyze security vulnerabilities. Further, the computer-actionable format may be one of a JavaScript Object Notation (JSON) format and an Extensible Markup Language (XML) format. Once the alert data is transformed, the vulnerability transformation engine 104 may store the transformed data associated with the security vulnerability alert in a database for determining whether an IT resource, from amongst the plurality of IT resources, is in a vulnerable state.

According to an example, the vulnerability assessment engine 106 may receive a request from a user of the IT resource to determine whether a component of the IT resource is in a vulnerable state. An IT resource is said to be in a vulnerable state if it is found to be exploitable due to security vulnerability. In an example, if an IT resource is a server, then a port may be a component of the server. Subsequent to the request, the vulnerability assessment engine 106 may obtain at least one resource attribute indicative of the IT resource from the user. The resource attribute may be indicative of at least one of a name of the IT resource, an OS running on the IT resource, a manufacturing date of the IT resource, a serial number of the IT resource, and a product number of the IT resource. For determining whether the component of the IT resource is vulnerable or not, the vulnerability assessment engine 106 may initially identify the IT resource.

Upon identification of the IT resource, the vulnerability assessment engine 106 may scan the IT resource to determine whether any of the components of the IT resource is in a vulnerable state. Based on the scan result, the vulnerability assessment engine 106 may notify the user that whether any component of the IT resource is in a vulnerable state or not. Further, in case the IT resource is in the vulnerable state, then the vulnerability assessment engine 106 may recommend a security patch to the user for fixing the security vulnerability.

Although implementations of handling security vulnerabilities in IT resources have been described in language specific to structural features and/or methods, it is to be understood that the present subject matter may not be limited to the specific features or methods described. Rather, the specific features and methods are disclosed and explained in the context of a few implementations for handling of security vulnerabilities in IT resources.

I/We claim:

1. A system comprising:
a processor;
a vulnerability transformation engine, coupled to the processor, to:
on finding a publication of a security vulnerability alert, extract alert data corresponding to the security vulnerability alert;
parse the alert data into a structured format; and
generate an input data file based on the parsed alert data; and
a vulnerability assessment engine, coupled to the processor, to:
based on the input data file, determine whether an Information Technology (IT) resource, implemented in a cloud environment, is in a vulnerable state.

2. The system as claimed in claim 1, wherein the alert data corresponding to the security vulnerability alert comprises at least one of a unique identifier associated with the security vulnerability alert, a name of a security vulnerability associated with the security vulnerability alert, a description of the security vulnerability, a security patch for fixing the security vulnerability, and an assigned priority level for the security vulnerability.

3. The system as claimed in claim 1, wherein the vulnerability transformation engine further is to:
monitor a plurality of data sources for published security vulnerability alerts pertaining to IT resources.

4. The system as claimed in claim 1, wherein to determine whether the IT resource is in the vulnerable state, the vulnerability assessment engine is to:
obtain a resource attribute indicative of the IT resource from a user of the IT resource;
identify the IT resource from amongst a plurality of IT resources based on the resource attribute;
scan the IT resource to determine whether the IT resource is in the vulnerable state, wherein the IT resource is scanned against the input data file; and
on determining the IT resource to be in the vulnerable state, notify the user of the IT resource that the IT resource is in the vulnerable state.

5. The system as claimed in claim 4, wherein on determining the IT resource to be in the vulnerable state, the vulnerability assessment engine is to:
recommend a security patch to the user of the IT resource for remediating security vulnerability.

6. A method comprising:
obtaining a list of published security vulnerabilities and a description associated with each of the published security vulnerabilities from a plurality of data sources;
transforming the description associated with each of the published security vulnerabilities into a computer-actionable format, wherein the computer-actionable format is a data format usable to analyze the published security vulnerabilities;
identifying at least one Information Technology (IT) resource, from amongst a plurality of IT resources, that is to be assessed for the published security vulnerabilities; and
assessing the at least one IT resource based on the transformed description associated with each of the published security vulnerabilities to determine whether the at least one IT resource is vulnerable to any of the published security vulnerabilities.

7. The method as claimed in claim 6, wherein a description associated with a published security vulnerability indicates a list of affected IT resources, versions of the affected IT resources, technical details of the published security vulnerability, current exploitation status of the published security vulnerability, and consequences of exploitation.

8. The method as claimed in claim 6 further comprising:
receiving an input from a user to determine whether a new security vulnerability is published for an IT vendor; and
accessing a data source of the IT vendor to determine whether the new security vulnerability is published.

9. The method as claimed in claim 6 further comprising:
receiving a request from a user of the at least one IT resource to determine whether the at least one IT resource is vulnerable to any of the published security vulnerabilities; and
upon receiving the request, obtaining a resource attribute indicative of the at least one IT resource from the user for identification of the at least one IT resource based on the resource attribute.

10. The method as claimed in claim 6 further comprising:
on determining the at least one IT resource to be vulnerable to any of the published security vulnerabilities, notifying a user of the at least one IT resource that the at least one IT resource is vulnerable, and recommending a remediation action to the user of the at least one IT resource for remediating the security vulnerability.

11. A non-transitory machine-readable storage medium having instructions executable by a processing resource to:
for a computing environment comprising a plurality of Information Technology (IT) resources, monitor a plurality of data sources for published security vulnerability alerts;
on finding a publication of a security vulnerability alert, extract alert data corresponding to the published security vulnerability alert;
transform the alert data corresponding to the published security vulnerability alert into a computer-actionable format, wherein the computer-actionable format is a data format usable to analyze security vulnerabilities; and
store the transformed alert data associated with the published security vulnerability alert in a database for determining whether an IT resource, from amongst the plurality of IT resources, is in a vulnerable state.

12. The non-transitory machine-readable storage medium as claimed in claim 11, wherein the alert data corresponding to the published security vulnerability alert comprises at least one of a unique identifier associated with the security vulnerability alert, a name of a security vulnerability associated with the security vulnerability alert, a description of the security vulnerability, a security patch for fixing the security vulnerability, and an assigned priority level for the security vulnerability.

13. The non-transitory machine-readable storage medium as claimed in claim 11, wherein the instructions are further executable to:
parse the alert data corresponding to the published security vulnerability alert into a structured format; and
store the parsed alert data in a database.

14. The non-transitory machine-readable storage medium as claimed in claim 11, wherein the instructions are further executable to:
receive a request from a user of the IT resource to determine whether a component of the IT resource is in a vulnerable state; and
upon receiving the request, obtain at least one resource attribute indicative of the IT resource from the user.

15. The non-transitory machine-readable storage medium as claimed in claim 14, wherein the instructions are further executable to:
identify the IT resource based on the at least one resource attribute indicative of the IT resource; and
scan the IT resource to determine whether the component of the IT resource is in the vulnerable state.
